(19) United States
(12) Patent Application Publication
(10) Pub. No.: US 2019/0389178 A1
(43) Pub. Date: Dec. 26, 2019

(54) STEEL MATERIAL COMPOSITE WITH INHOMOGENEOUS PROPERTY DISTRIBUTION

(71) Applicants: thyssenkrupp AG, Essen (DE); THYSSENKRUPP STEEL EUROPE AG, Duisburg (DE)

(72) Inventors: Jens-Ulrik BECKER, Duisburg (DE); Stefan MYSLOWICKI, Monchengladbach (DE)

(21) Appl. No.: 16/481,733

(22) PCT Filed: Jan. 30, 2017
(86) PCT No.: PCT/EP2017/051925

§ 371 Date: Jul. 29, 2019

(51) Int. Cl. B32B 15/01; C22C 38/22; C22C 38/04; C22C 38/00; C22C 38/06; C22C 38/02; C22C 38/26; C22C 38/24; C22C 38/28; B23K 20/04; B23K 20/227

(52) U.S. Cl. CPC B32B 15/011; C22C 38/22; C22C 38/04; C22C 38/002; C22C 38/06; B23K 2101/006; C22C 38/26; C22C 38/24; C22C 38/28; B23K 20/04; B23K 20/227; C22C 38/02

(57) ABSTRACT

The present invention relates to a steel material composite, comprising a core layer of a higher-strength or high-strength steel and, integrally bonded to the core layer on one or both sides, an outer layer of ferritic, chemically resistant steel. Corresponding flat steel products are distinguished by favourable properties with respect to their strength, ductility, low sensitivity to hydrogen-induced crack formation and favourable corrosion resistance. The present invention also relates to a method for producing a corresponding steel material composite and to the use of such steel material composites in vehicle structures and in particular in bodywork structures.

The present invention relates to a steel material composite, comprising a core layer of a higher-strength or high-strength steel and, integrally bonded to the core layer, an outer layer of ferritic, chemically resistant steel on one or both sides of the core layer. Furthermore, the present invention relates to the use of a layer of ferritic, chemically resistant steel as a plating layer on a higher-strength or high-strength steel layer core for improving the bending properties of the steel material composite, and also to a method for producing a steel material composite as given above, and to its use in vehicle structures.

### PRIOR ART

With automotive structural components, the manufacturing technology by means of press-hardening is of considerable importance. In many places attempts are being made to extend the range of materials which are used with this method. With strength/ductility, which hitherto had been solved advantageously in the prior art by steel material composites, increasingly other stated problems, such as imparting insensitivity to delayed fracture and also protection against corrosion on the finished component, also play a major part.

With monolithic steel grades there is the problem that an increase in strength is always accompanied by a drop in ductility. This relates especially to hot-forming steels, which through the operation of press-hardening can attain very high strengths of over 2000 MPa, and thus have extremely low residual ductilities. The use of a composite structure which in principle is intended to serve to break the connection described between strength and ductility in that a high-strength core material having a high carbon content is covered by two plating layers having a low carbon content which are comparatively soft, so that higher overall deformations can be achieved for example under bending load, is known from the specification DE 10 2008 022 709 A1.

During the production in the context of hot roll cladding and the further processing, for example in the course of the heating of such a material which is necessary for press-hardening, diffusion processes take place which to a certain extent effect equalisation of the carbon content over the material cross-section. Owing to the process times used industrially, the overall equalisation is however not achieved fully, but a profile with an increase in the carbon content from the material surface towards its core is formed. This uniformly increasing concentration profile results in a likewise uniform increase in strength over the cross-section, which has advantages with respect to avoidance of abrupt transitions between the layers (notch effect).

In addition to the multi-layer material mentioned, there is also the possibility of increasing the ductility through decarburisation processes during or in heat treatment. In this case, it is inherent in the process, however, that only surface effects, and not influencing of the material in the interior, occur.

In the case of materials which are sensitive to delayed cracking, in a hydrogen-containing environment at critical mechanical loading cracking occurs in the steel material. In order to prevent or suppress this, a flat steel product in the form of a multilayer material composite in which a stronger steel having a carbon content of more than 0.26% by weight with an outer layer consisting of a steel having a lower carbon content of especially at most 0.13% by weight is produced is proposed in EP 2 886 332 A1.

Since monolithic steels used for the intended purpose of “hot forming” in general, and especially the material composites which are described in EP 2 886 332 A1, are used with an AlSi coating, there is here the general disadvantage that this coating upon the heating of sheets for press-hardening results in an absorption of hydrogen from the furnace atmosphere which is then incorporated in the material. This hydrogen can no longer escape, and may possibly result in a critical hydrogen content which then in interaction with the strength attained upon hardening can favour the occurrence of hydrogen-induced cracks.

The formulation of steel materials with improved corrosion resistance is likewise the subject of intensive investigations. For example, the use of high-grade steels for hot forming is discussed in WO 2012/146384 A1. In this document, especially the use of materials which through their alloy design with the added alloying elements aluminium and silicon are resistant to high-temperature oxidation is described. The named alloying elements, owing to their ability to form a dense, securely adhering scale layer on the metal surface, ensure resistance of the material to high-temperature oxidation.

While the different problem formulations of the requirements high-strength/high ductility, resistance to delayed cracking and corrosion resistance were tackled in the prior art with different methods and approaches, hitherto no steel material has been known in which all four requirements, i.e. those of strength, ductility, low sensitivity to hydrogen-induced cracking and corrosion resistance, can be combined in a desirable manner.

The present invention is therefore concerned with the problem formulation of proposing a material which meets all of the aforementioned four requirements in a desirable manner.

### PRESENTATION OF THE INVENTION

Accordingly, a first aspect of the present invention relates to a steel material composite, comprising a core layer of a higher-strength or high-strength steel and, integrally bonded to the core layer, an outer layer of ferritic, chemically resistant steel on one or both sides of the core layer.

A “higher-strength or high-strength” steel within the scope of the present invention is understood to mean a steel which has a tensile strength of at least 1000 MPa and especially of at least 1200 MPa in the heat-treated, especially in the hardened, state.

“Ferritic, chemically resistant steel” in the context of the present invention is considered to be steels with a minimum content of chromium of 10% by weight, relative to the total weight. A range of approximately 12 to 30% by weight can be given as the preferred chromium content.

Preferably the core layer has an outer layer of ferritic, chemically resistant steel on both sides. Furthermore, one or both outer layers of the steel material composite may have a coating in each case on the outer side, especially an aluminium-based, zinc-based and/or paint-based coating.

According to the invention, the ferritic, chemically resistant steel has a content of ≤0.07% by weight of carbon, ≤1% by weight of manganese, 12 to 30% by weight of chromium, ≤7% by weight of molybdenum, ≤0.05% by weight of in each case phosphorus and sulphur, ≤0.5% by weight of silicon, ≤0.5% by weight of aluminium, and ≤1% by weight of in each case titanium, niobium, vanadium and zirconium, with titanium, niobium, vanadium and zirconium in total making up a proportion of >0.1% by weight, and the remainder being iron and unavoidable impurities.

A content of 0.01% by weight in each case can be given as the preferred minimum proportion of manganese and/or molybdenum. Furthermore, it is in accordance with the invention that the ferritic, chemically resistant steel of the steel material composite according to the invention has a proportion of titanium, niobium, vanadium and/or zirconium in total which is greater than unavoidable impurities, and especially in the range of 0.1 to 2.0% by weight, preferably 0.25 to 1.5% by weight, and especially preferably 0.3 to 1.2% by weight, relative to the total amount of titanium, niobium, vanadium and zirconium. In this case it is not necessary for the ferritic, chemically resistant steel of the steel material composite to contain all four of the named constituents, but it is also possible for the content to result from only one, two or three of the named elements. The elements titanium, niobium, vanadium and/or zirconium owing to their binding to carbon which is preferred over chromium ensure that the corrosion-relevant free chromium content is not reduced by carbide formation.

With regard to the carbon content, within the scope of the present invention for the ferritic, chemically resistant steel contents of ≤0.05% by weight, and especially ≤0.04% by weight, are considered to be preferable, and ≤0.03% by weight as more preferable. The reduction of the carbon in combination with the alloying elements titanium, niobium, vanadium and/or zirconium contributes to keeping the carbide formation as low as possible and as a consequence the corrosion resistance as high as possible.

Furthermore, it is considered to be preferable for the ferritic, chemically resistant steel that it should have a chromium content of ≥12% by weight, especially ≥16% by weight, and preferably ≥20% by weight.

With regard to the aluminium content and/or silicon content, within the scope of the present invention contents of ≤0.5% by weight of silicon and/or ≤0.5% by weight of aluminium, especially ≤0.4% by weight of silicon and/or ≤0.4% by weight of aluminium, are considered to be more preferable for the ferritic, chemically resistant steel of the steel material composite according to the invention. Aluminium and/or silicon may also be contained only as impurities and/or normal accompanying elements. Owing to this limitation, the formation of a especially effectively adhering, dense oxide layer (characteristic of high temperature protection) can be substantially prevented, since this layer would lead in the production processes (hot rolling, press-hardening) to a surface covering which can be removed only at very great expense or only inadequately and which is very disadvantageous. Furthermore, due to the limitation of aluminium and/or silicon the weldability can also be improved.

As examples of representatives of a ferritic, chemically resistant steel which can be used in the context of the present invention, mention may be made for example of steels having the designation 1.4509, 1.4510, 1.4511 and 1.4613, which are especially not limited to these.

The higher-strength or high-strength steel of the core layer expediently in contrast has a higher carbon content of ≥0.15% by weight, more preferably ≥0.20% by weight, and especially preferably ≥0.25% by weight. Examples of steels which can be used as the core layer are inter alia hot-formed steels, especially manganese/boron steels, such as for example 22MnB5, 35MnB5, 37MnB4 or 40MnB4, the latter of which have carbon contents in the range from 0.34 to 0.40% by weight. The carbon content may also be more than 0.4% by weight, and for example be limited to at most 0.55% by weight.

In addition to carbon, the steel of the core layer preferably likewise has a content of Mn and B, it being possible to give a range from 0.6 to 2% by weight and especially 0.8 to 1.4% by weight as a suitable content of Mn. A beneficial content of B lies in the range from 0.0005 to 0.01, especially 0.001 to 0.005, and preferably 0.002 to 0.004. It goes without saying that only those properties of the alloying elements which primarily determine the steel of the core layer are mentioned here, and that the steel may contain further alloying elements in effective contents in order to develop certain properties in each case.

The steel used as the core layer in the finished hardened state expediently has a tensile strength of more than 1500 MPa and especially more than 1650 MPa.

The steel material composite according to the invention is based on an outer layer of ferritic, chemically resistant steel, which in turn should have a lower tensile strength than the steel of the core layer. For example, it is preferable if the ferritic, chemically resistant steel has a tensile strength of <1200 MPa, especially of <1000 MPa, and preferably of <800 MPa. Using a ferritic, chemically resistant steel with relatively low strength ensures that a sufficiently high ductility is imparted to the resulting steel material composite. Furthermore, the ferritic, chemically resistant steel, in the temperature ranges of the production and hot forming, should be free from transformation and hence not be able to form a hardness structure. Ductility and freedom from transformation together with the omission of the AlSi coating otherwise preferably used in the hot forming/press-hardening permit especially low sensitivity to hydrogen-induced cracking in the higher-strength and ultra-high-strength steel material composites according to the invention.

The ferritic, chemically resistant steel in the outer layer because of its ferritic lattice structure has low solubility for carbon, and this is maintained between ambient temperature (23° C.) and the usual process temperatures for hot roll cladding and the heating necessary in the course of the press-hardening. This means that the attempts to equalise the concentration gradient between the core and the plating layer material (i.e. outer layer) is compensated by the formation of a carbon-rich phase at the transition of both regions. The steel material composite in accordance with the invention described above therefore preferably has a maximum in the carbon content in the region of joining of the higher-strength or high-strength steel and the ferritic, chemically resistant steel which is at least 1.2 times, and preferably at least 2 times, the carbon content of the ferritic, chemically resistant steel. In this case, the development of the maximum and the extent and the width of the region with lowered carbon content (in the outer layer) is dependent on process parameters in context with the introduction of heat, such as especially the time and extent thereof.

Over the material cross-section in the region compared with known composites (see FIG. 1) an additional ductile region is thus yielded (see FIG. 2), via which the deformation ability of the overall composite can be positively influenced by the selection of the production and processing parameters and the associated precipitation processes in addition to the known soft plating layers. Surprisingly, it has been shown in the investigations on which the present invention is based that the zone associated with the formation of the ductile region described, in which zone the maximum of the carbon concentration lies, does not substantially adversely influence the ductility of the overall composite.

Within the scope of the present invention, it is furthermore preferable if the steel material composite especially in the finished, heat-treated state has a tensile strength of >1200 MPa, and especially >1400 MPa, on average over the total thickness of the composite or the material cross-section of the composite.

With regard to the thickness of the core layer and the outer layer, the present invention is not subject to any substantial restrictions, with the proviso that the outer layer should have a lesser thickness than the core layer, in order to obtain a steel material composite which has beneficial values in relation to its strength properties. A range of between 2 and 15%, especially between 4 and 10%, and preferably between 5 and 8%, relative to the total thickness of the composite, can be given for the thickness of the outer layer per side. Owing to the use of the outer layer, especially the strength of the composite is not significantly reduced compared with the strength of the monolithic (core) material.

The steel material composite according to the invention may in addition to the core layer and outer layer have further coatings, such as for example further anti-corrosion coatings, on the respective outer side of the steel material composite. For example, the steel material composite may be hot-dip galvanised or anodised. In addition, additionally or alternatively zinc-based and aluminium-based coatings and also paint-based coatings of any type are conceivable. In the simplest embodiment, one core layer and only one outer layer are provided as steel material composite, the outer layer or the core layer or both layers having a coating on the outer side. If the steel material composite consists of a core layer and two outer layers, one outer layer or alternatively both outer layers may have a coating on the outer side. Alternatively or additionally, within the scope of the invention a coating may also be provided between the core layer and outer layer.

One further aspect of the present invention relates to the use of a layer of ferritic, chemically resistant steel, as described above, with a carbon content of ≤0.07% by weight, ≤1% by weight of manganese, 12 to 30% by weight of chromium, ≤7% by weight of molybdenum, ≤0.05% by weight of in each case phosphorus and sulphur, ≤0.5% by weight of aluminium, ≤0.5% by weight of silicon, ands ≤1% by weight of in each case titanium, niobium, vanadium and zirconium, with titanium, niobium, vanadium and zirconium in total making up a proportion of >0.1% by weight, and the remainder being iron and unavoidable impurities, as a plating layer on a higher-strength or high-strength steel layer core for improving the bending properties of the steel material composite.

One additional further aspect of the present invention relates to a method for producing a steel material composite as described above, comprising the provision of a higher-strength or high-strength steel as core layer, the laying of a layer of ferritic, chemically resistant steel with a carbon content of ≤0.07% by weight on one or both sides of the steel of the core layer, and the joining of the core layer and layer of ferritic, chemically resistant steel under suitable conditions.

Said method is expediently configured such that the joining of the steel of the core layer and of the layer of ferritic, chemically resistant steel takes place by hot roll cladding. The hot roll cladding in this case preferably takes place at a temperature in the range of 800° C. to 1250° C.

One further aspect of the present invention relates to a steel material composite which can be produced according to this method.

One further aspect of the present invention finally relates to the use of a steel material composite, as described above, in a vehicle structure and preferably in a bodywork structure. It is especially preferable if the use is for a B-pillar, structural components in the power flow, gusset plates, seat rails, components with high strength requirements which are at risk of corrosion, such as chassis, tanks, crash boxes, side members or battery boxes. In this application, the properties of the composite material which can be set or combined flexibly can be used especially advantageously. The steel material composite may also be designed as a tailored product, preferably as a flexibly rolled product with different thicknesses.

There are many different possible ways of configuring and refining the multi-layer steel material composite. On this point, reference is made on one hand to the claims which depend from independent Claim 1 and on the other hand to the examples of embodiment.

### BRIEF DESCRIPTION OF THE DRAWINGS

FIG. 1 A shows a section through a conventional C-steel/C-steel material composite. The carbon concentration profile of this steel is illustrated in B. A uniformly rising concentration profile is shown which leads to a uniform increase in strength over the cross-section.

FIG. 2 A shows a section through a chemically resistant steel (ferrite)/C-steel material composite in accordance with the present invention. The carbon profile resulting in this case over the material cross-section B shows the occurrence of a concentration maximum at the boundary layer between the ferritic plating layer and core material. This results in the material next to the core material in the initial state having a further region with a lowered C content (C sink). This region owing to the lower carbon content upon heating to an austenitising temperature in conjunction with press-hardening will attain a lower martensitic hardness than the non-influenced core having a higher carbon content.

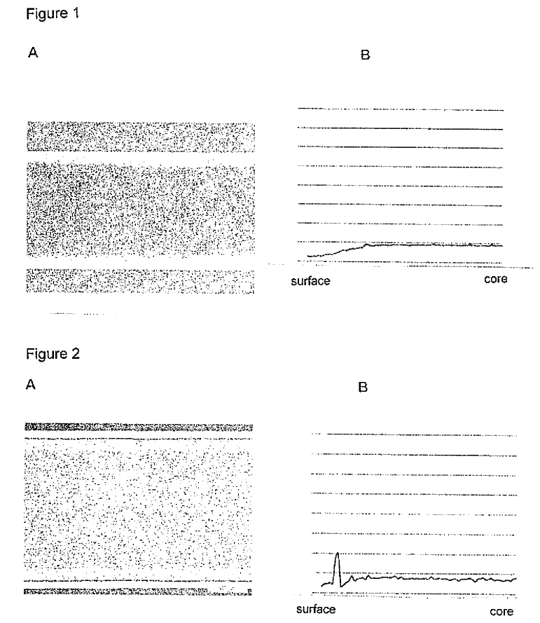

1. A steel material composite, comprising a core layer of a higher-strength or high-strength steel and, integrally bonded to the core layer, an outer layer of ferritic, chemically resistant steel on one or both sides of the core layer, wherein the ferritic, chemically resistant steel contains ≤0.07% by weight of carbon, ≤1% by weight of manganese, 12 to 30% by weight of chromium, ≤7% by weight of molybdenum, ≤0.05% by weight of in each case phosphorus and sulphur, ≤0.5% by weight of aluminium, ≤0.5% by weight of silicon, and ≤1% by weight of in each case titanium, niobium, vanadium and zirconium, with titanium, niobium, vanadium and zirconium in total making up a proportion of >0.1% by weight, and the remainder being iron and unavoidable impurities.

2. A steel material composite according to claim 1, wherein the ferritic, chemically resistant steel has a tensile strength of <1000 MPa.

3. A steel material composite according to claim 1, wherein the ferritic, chemically resistant steel has a chromium content of ≥16% by weight.

4. A steel material composite according to claim 1, wherein the higher-strength or high-strength steel has a carbon content of ≥0.15% by weight.

5. A steel material composite according to claim 1, wherein the carbon content in the region of joining of the higher-strength or high-strength steel and the ferritic, chemically resistant steel has a maximum which is at least 1.2 times, the carbon content of the ferritic, chemically resistant steel.

6. A steel material composite according to claim 1, which has a strength of >1200 MPa on average over the total thickness of the composite.

7. A steel material composite according to claim 1, wherein the steel material composite in addition to the core layer and outer layer includes further coatings, on the respective outer side of the steel material composite.

8. A layer of ferritic, chemically resistant steel with a carbon content of ≤0.07% by weight, ≤1% by weight of manganese, 12 to 30% by weight of chromium, ≤7% by weight of molybdenum, ≤0.05% by weight of in each case phosphorus and sulphur, ≤0.5% by weight of aluminium, ≤0.5% by weight of silicon, and ≤1% by weight of in each case titanium, niobium, vanadium and zirconium, with titanium, niobium, vanadium and zirconium in total making up a proportion of >0.1% by weight, and the remainder being iron and unavoidable impurities, said layer comprising a plating layer on a higher-strength or high-strength steel layer core for improving the bending properties of the steel material composite.

9. A method for producing a steel material composite according to claim 1, comprising the provision of a higher-strength or high-strength steel as core layer, the laying of a layer of ferritic, chemically resistant steel on one or both sides of the steel of the core layer, and the joining of the steel substrate and layer of ferritic, chemically resistant steel under suitable conditions.

10. A method according to claim 9, characterised in that the joining of the steel of the core layer and layer of ferritic, chemically resistant steel takes place by hot roll cladding.

11. A steel material composite according to claim 1 as a component of a vehicle structure.

12. The component of claim 11, characterised in that the vehicle structure is for a B-pillar, structural components in the power flow, gusset plates, seat rails, components with high strength requirements which are at risk of corrosion, such as chassis, tanks, crash boxes, side members or battery boxes.

13. A steel material composite according to claim 1, wherein the ferritic, chemically resistant steel has a chromium content of ≥20% by weight.

14. A steel material composite according to claim 1, wherein the higher-strength or high-strength steel has a carbon content of ≥0.20% by weight.

15. A steel material composite according to claim 1, wherein the higher-strength or high-strength steel has a carbon content of ≥0.25% by weight.

16. A steel material composite according to claim 1, wherein the carbon content in the region of joining of the higher-strength or high-strength steel and the ferritic, chemically resistant steel has a maximum which is at least 2 times the carbon content of the ferritic, chemically resistant steel.

17. A steel material composite according to claim 1, wherein the steel material composite in addition to the core layer and outer layer includes aluminium-based, zinc-based or paint-based coatings, on the respective outer side of the steel material composite.
